(19) United States
(12) Patent Application Publication
(10) Pub. No.: US 2005/0103838 A1
(43) Pub. Date: May 19, 2005

(54) Method and apparatus for electronically exchanging and storing an image of a business card along with associated card information

(75) Inventors: Roger M. Slotkin, Long Beach, NY (US); Mark C. Robinson, Amherst, NH (US)

Correspondence Address: HELLER EHRMAN WHITE & MCAULIFFE LLP, 1717 RHODE ISLAND AVE, NW, WASHINGTON, DC, 20036-3001, US

(73) Assignee: Zap Card Corporation, Long Beach, NY (US)

(21) Appl. No.: 10/715,599

(22) Filed: Nov. 19, 2003

(51) Int. Cl. G06K 5/00

(52) U.S. Cl. 235/380

(57) ABSTRACT

An electronic business card device is provided including a memory constructed and adapted to store at least one electronic business card consisting of at least an image of a business card along with associated card information derivable from and associated with the business card, a sending mechanism constructed and adapted to send a stored electronic business card to other devices, a receiving mechanism constructed and adapted to receive an electronic business card and associated card information from another device, and a storing mechanism constructed and adapted to selectively store the received electronic business card in the memory, the storing being based at least in part on at least some of the received associated card information.

### BACKGROUND OF THE INVENTION

1. Field of the Invention

The present invention relates generally to the exchange and storage of contact information, and more particularly to a method and apparatus for electronically exchanging and storing contact information, such as electronic business cards.

2. Description of the Related Art

People have been exchanging business cards for many years. Known business cards typically have an image printed on an inexpensive material such as paper or plastic, and are physically exchanged between people, such as via person exchanges or business cards being included in a shipped parcel. These conventional business cards, however, can be easily lost or damaged, and a person carrying her business cards for exchange may run out of them when exchanging a large number of business cards (e.g., while attending a convention or conference). Additionally, information on these cards may become outdated, e.g., when an address or phone number changes, causing printed conventional business cards to be of little use. Thus, a need exists for an alternative to the conventional business card.

Electronic business cards have been proposed. One such example is set forth in U.S. Pat. No. 6,561,420 to Tsai (“Tsai” hereafter), which is incorporated by reference herein in its entirety. Tsai discloses an information card including humanly visible indicia on its front and strip zones and a ring zone on its back. The humanly visible indicia resembles a conventional business card, including information such as a person's name and title, the company they represent, and an address and contact data. The strip zones and the ring zone are magnetically readable and writable, so as to be accessible by a reader device. These zones are used to convey a superset of the data present in the humanly visible indicia on the front of the information card.

As with conventional business cards, however, Tsai still requires a physical card and specialty card reader to convey the superset of data. Thus, the Tsai information card can still be lost or physically damaged, and a specialty card reader must be provided to a recipient of the information card. Hence, a need still exists for an improved business card that does not require a physical card to convey the superset of data, or a specialty card reader to read the physical card.

Other problems with the prior art not described above can also be overcome using the teachings of the present invention, as would be readily apparent to one of ordinary skill in the art after reading this disclosure.

### SUMMARY OF THE INVENTION

According to one embodiment of the present invention, an electronic business card device is provided including a memory constructed and adapted to store at least one electronic business card consisting of at least an image of a business card along with associated card information derivable from and associated with the business card, a sending mechanism constructed and adapted to send a stored electronic business card to other devices, a receiving mechanism constructed and adapted to receive an electronic business card and associated card information from another device, and a storing mechanism constructed and adapted to selectively store the received electronic business card in the memory, the storing being based at least in part on at least some of the received associated card information.

According to another embodiment of the present invention, in a system using electronic business card devices, a method performed by a first electronic business card device is provided, the method including storing an electronic business card consisting of at least an image of a business card along with associated card information derivable from and associated with the business card, communicating with a second electronic business card device to determine whether a current version of the stored electronic business card has been sent to the second electronic business card device, and, based on the determining, sending at least the image of the stored business card and the associated card information derivable from and associated with the business card to the second electronic business card device when the current version of the stored electronic business card has not been sent to the second electronic business card device.

According to another embodiment of the present invention a program product is provided, the program product causing a first electronic device to perform a method of storing a first electronic business card consisting of at least an image of a first business card along with associated card information derivable from and associated with the first business card, sending at least the image of the first business card and the associated card information derivable from and associated with the first business card to a second electronic device, receiving a second electronic business card consisting of at least an image of a second business card along with associated card information derivable from and associated with the second business card, and storing the received second electronic business card, wherein stored electronic business cards are indexed by the associated card information derivable from and associated therewith.

### BRIEF DESCRIPTION OF THE DRAWINGS

FIG. 1 depicts a business card exchange environment according to an embodiment of the present invention.

FIG. 2 depicts a generic electronic device usable with various embodiments of the present invention.

FIG. 3 depicts a server for creating electronic business cards according to an embodiment of the present invention.

FIG. 4 depicts an electronic business card exchange between two electronic devices according to an embodiment of the present invention.

FIG. 5 depicts a key fob device usable with various embodiments of the present invention.

FIG. 6 depicts the key fob device of FIG. 5 without an outer casing for purposes of illustration.

### DETAILED DESCRIPTION OF THE EXEMPLARY EMBODIMENTS

Reference will now be made in detail to exemplary embodiments of the present invention. Wherever possible, the same reference numbers will be used throughout the drawings to refer to the same or like parts.

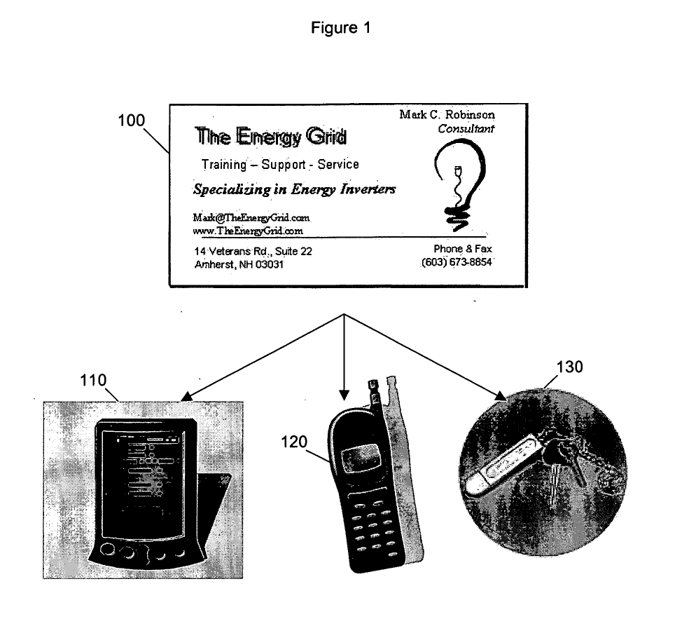

A business card exchange environment according to one embodiment of the present invention is depicted in FIG. 1. In particular, the business card 100 depicted is to be exchanged between two or more of electronic devices 110 (personal digital assistant (PDA)), 120 (cellular phone), and 130 (key fob). It should be appreciated that, preferably, the business card 100 may be exchanged between two or more of the same type of electronic device (e.g., 110, 120 or 130), and/or between differing types of electronic devices (e.g., 110, 120 and 130). However, a specialty system could be implemented useable with only one type of device, such as between compatible PDAs 110. Additionally, while PDAs, cellular phones, and key fobs are shown, other electronic devices including specialty devices are also contemplated.

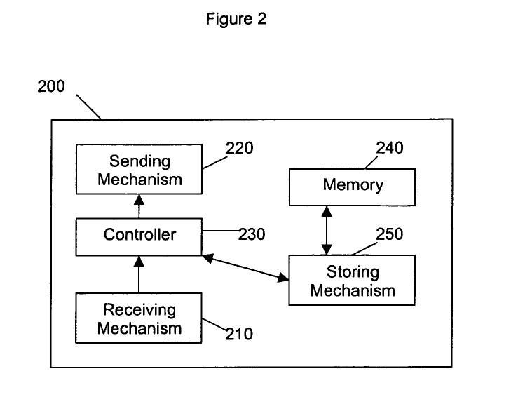

As shown by the block diagram of exemplary generic electronic device 200 in FIG. 2 (which may be incorporated into any one of devices 110, 120 and 130 to facilitate electronic transmission and receipt of business card 100), the electronic device 200 preferably includes a wireless sending mechanism 220, such as an infra-red (IR), radio frequency (RF) or Bluetooth transmission device. Of course, physical sending mechanisms 220 can also be used, such as transmitters for communicating via a cable (e.g., an Ethernet cable, a telephone line, a serial cable, etc.) or the like. In addition to the sending mechanism 220, each electronic device 200 preferably includes a wireless receiving mechanism 210 to facilitate electronic receipt of the business card 100 (analogous to the wireless sending mechanism 220), though a physical receiving mechanism 210 could also be used (analogous to the physical sending mechanism 220). Receiving mechanism 210 and sending mechanism 220 may be provided in a single integrated device, or as separate components as shown.

In addition to the receiving mechanism 210 and sending mechanism 220, a controller 230 is provided, such as an appropriately programmed microprocessor, an application specific integrated circuit (ASIC), or the like. The controller 230 is configured to control the transmission and receipt of business card 100 via the sending mechanism 220 and receiving mechanism 210 respectively. Further, the controller 230 is configured to selectively store business card 100 in memory 240 using storing mechanism 250. Storing mechanism 250 may include an interface for coupling to a removable memory 240, such as SD RAM, compact flash, or memory stick. Other components (e.g., a display, keyboard, etc. coupled to controller 230) may also be provided, as would be readily apparent to one of ordinary skill in the art after reading this disclosure.

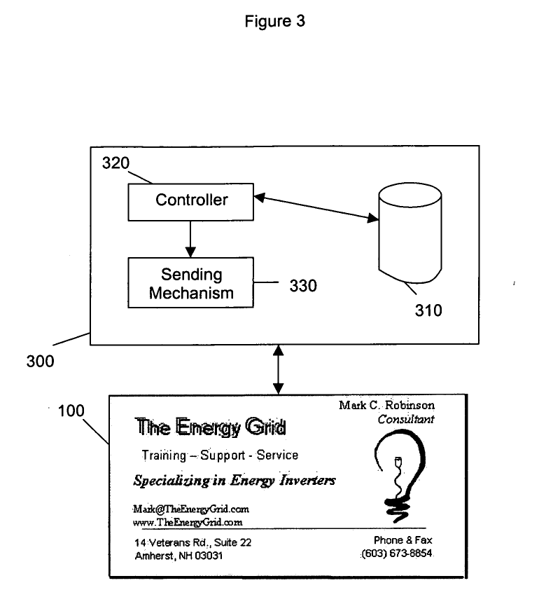

Preferably, a user creates his or her business card 100 using a WebSite accessible via the Internet (or hosted on an Intranet site) by server 300 shown in FIG. 3. The exemplary server 300 includes a controller 320 constructed and adapted to access and maintain database 310 of business cards 100 and to interface with the user (e.g., via the Internet) to create a customized business card 100 for the user.

To create a business card 100, a user may access the WebSite and be guided by controller 320 through a business card creation process, such as the controller 320 prompting the user to enter contact information, to provide an electronic copy of the user's corporate logo, etc. Alternatively, the business card creation process may encompass providing the WebSite with an electronic copy of the image of the user's conventional business card, such as a scanned or digitally photographed copy thereof, and configuring the WebSite to extract the necessary information through an optical character recognition (OCR) process or the like. The created business card 100 may then be stored in database 310 and downloaded into memory 240 of device 200 in a known manner. Preferably, the business card 100 is stored in a vCard compatible format for standardized exchange thereof, as described at http://www.imc.org/pdi/.

According to one aspect of the present invention, the business card 100 (e.g., a received business card 100 from another device) may be indexed in memory 240 based on associated card information derivable from and associated with the business card 100, such as the business card sender's name, telephone number, email address, etc. Upon receipt of a business card 100 (e.g., via downloading a user's own business card 100 from server 300 or via receiving another user's business card 100 during an exchange of business cards 100) device 200 stores the business card 100 in memory 240 as previously described, with appropriate indexing. In some embodiments of the invention, a recipient may selectively store a received business card based upon derivable information from the card (e.g., a name, phone number, company name and the like) or based on user-selected criteria. For example, a user may chose to store a card under one or more user-defined categories such as “Friends”, “Family”, “Work”, “Home Repair” and the like. In this manner a recipient of a business card is able to selectively organize the card in an appropriate and useful manner. Of course the recipient may also chose to ignore the card, let it be automatically categorized or to delete the card.

Additionally, the device 200 may index stored business cards 100 based on multiple portions of the associated card information. By providing indexing based on multiple portions of the associated card information (e.g. user name, phone number, and email address), the user can more easily and quickly locate a desired business card stored within the device 200 by searching on any one of the multiple portions. Thus, the present invention provides numerous accessibility benefits over previously disclosed electronic business cards.

Further, the device 200 preferably sends and/or stores an image of the received business card 100 along with the associated card information thereof, such as a JPEG or GIF of the entire business card at actual size. By storing the image of the received business card 100 in addition to the associated card information rather than just the associated card information or just the image of the received business card 100, the recipient will have an exact replica of the sender's business card 100 and will still be able to integrate the associated card information for other uses (e.g., indexing/emailing/etc.). By way of example, when the user later retrieves the received business card 100 for use (e.g., when a user looks up an individual in his address book to set up a meeting therewith), the device 200 can display an exact replica of the received business card 100 and, if the device 200 includes cellular phone capabilities, can still auto-dial the contact from the associated card information.

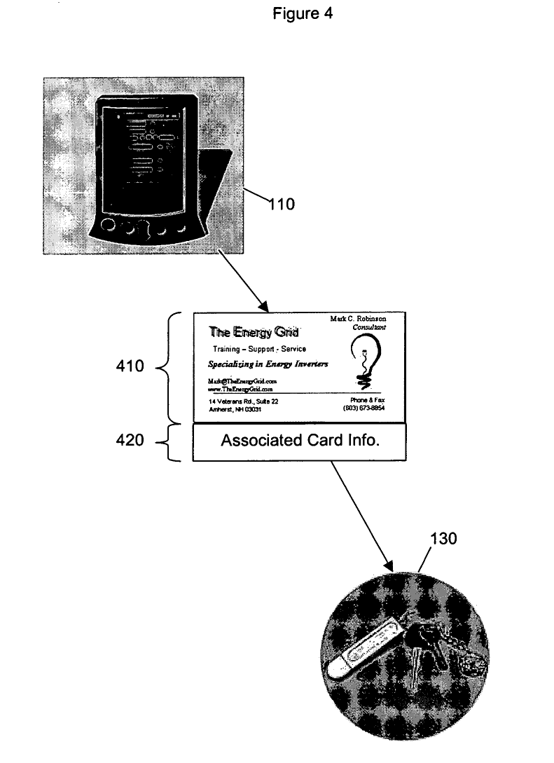

An example of an exchange of electronic business cards is shown in FIG. 4. In particular, PDA 110 is depicted sending an electronic business card to key fob 130. The PDA 110 sends an image 410 of the electronic business card along with the associated card information 420 to the key fob 130. The PDA 110 may also send an image of the corporate logo (e.g., a JPEG or GIFF file) rather than the image 410 of the electronic business card or in addition to the image 410 of the electronic business card. In this manner, key fob 130 receives and stores both the image 410 of the electronic business card and the associated card information 420. In this example, associated card information may include the sender's name (Mark C. Robinson) and title (Consultant), the company name (The Energy Grid), the corporate WebSite address (www.TheEnergyGrid.com), the sender's telephone number (603-673-8854), the sender's email address (Mark@TheEnergyGrid.com), the sender's address (14 Veterans Rd., Suite 22, Amherst, N.H. 03031), a date transmitted, a version identifier, a GPS location, and a sound file including the correct pronunciation of the sender's name (e.g., a WAV file or MP3 file). Other configurations are also plausible.

According to another embodiment of the present invention, the server 300 may include a sending mechanism 330 constructed and adapted to send updated business cards 100 for a given user to recipients of that user's business card. By way of example, every time a given user exchanges his business card 100 with someone (e.g., the device 200 including a tracking mechanism constructed and adapted to track other devices to which it sends business card 100) or for selected recipients of the user's business card 100, the user may register the recipient with the server 300. This registration can be stored along with the user's business card 100 in database 310. Should the user ever update his business card, such as when changing employers, after receiving a promotion, etc., the server 300 can automatically (or based on appropriate user input) send updated business cards 100 to recipients of that user's business card (e.g., via email). In this manner, the user's professional contacts will always have the most current contact information for the user.

Devices to which a card has been sent may be tracked based, e.g., on some unique identify of such devices. Examples include tracking devices based on their MAC addresses, a processor identity or the like.

Alternatively, when a first user exchanges his business card 100 with a second user, the first user's device 200 (i.e., the one sending the business card 100) may communicate with the second user's device 200 (i.e., the one receiving the business card 100) to determine whether a current version of the stored electronic business card 100 has been sent to the second device 100. Based on this determination, the first user's device 200 may send an updated business card 100 to the second user's device 200 when the current version of the stored electronic business card 100 has not been sent to the second user's device 200. In this manner, whenever two users meet, they can easily update contact information without having to know if they have already done so in the past. This technique may, of course, be used in conjunction with or separately from the server 300 based technique described above. Furthermore, the first and second devices may be configured to synchronize all of their common contacts, such that both the first and second devices are updated to have the most current contact information for all common contacts. This provides an enhanced method of maintaining contact information via electronic devices.

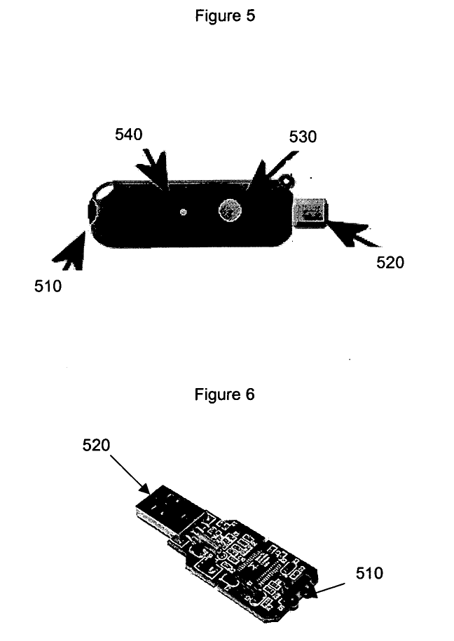

According to one preferred embodiment of the present invention, an electronic business card exchange occurs between one or more custom key fob devices as shown in FIGS. 5 and 6. The key fob device shown includes a universal serial bus (USB) connector 520 as a physical sending/receiving mechanism, an IR port 510 as a wireless sending/receiving mechanism, and a send/receive button 530 to initiate an exchange of business cards. Additionally, an indicator light 540 may be provided for communicating with a user (e.g., to indicate a successful or failed exchange of business cards, to indicate a low battery situation, etc.). Preferably, the key fob has a size not more than 2″×1″×0.5″ to facilitate easy carrying.

As with previously described embodiments, the electronic business card is preferably created on a personal computer (PC) or WebSite accessible by the user. The user may then download the electronic business card from the PC/WebSite using the USB connector 520. The electronic business card is then stored in a memory on the key fob preferably having a capacity of at least 64 megabytes for exchange and storage of electronic business cards.

To initiate an exchange of business cards, a user points the key fob at another electronic device (e.g., 110, 120 or 130 of FIG. 1), and presses the send/receive button 530 for a sufficient period of time to initiate the transfer (e.g., about 0.5 seconds). The indicator light 540 may then blink (e.g., once) when the send/receive button 530 is depressed, turn on steady when the other device is contacted (at which point the user may release the send/receive button 530), shut off when the exchange is complete, and blink multiple times (e.g., twice) to indicate a successful exchange. A similar process may be used with a receiving key fob of like kind.

Alternatively, the key fob may be configured to include an auto send/receive feature. By way of example, the key fob may exchange business cards automatically whenever another compatible device is detected (e.g., by periodically scanning using IR port 510). Other techniques are also contemplated.

The key fob device shown in FIGS. 5 and 6 is thus one example of custom electronic devices usable with various embodiments of the present invention. Other electronic devices usable with the present invention are also contemplated.

The term “business card” as used herein is intended to include any kind of card having an image and related information stored thereon. A “business card,” as used herein, is not limited to cards used only for formally structured businesses. For example, and without limitation, a business card may include a personal identification card, a club membership card, a driver's license and the like.

In some embodiments, the exchange of information between devices may be in some protected (e.g., encrypted) form.

The foregoing description of various embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

1. An electronic business card device comprising:
a memory constructed and adapted to store at least one electronic business card consisting of at least an image of a business card along with associated card information derivable from and associated with the business card;
a sending mechanism constructed and adapted to send a stored electronic business card to other devices;
a receiving mechanism constructed and adapted to receive an electronic business card and associated card information from another device; and
a storing mechanism constructed and adapted to selectively store the received electronic business card in the memory, the storing being based at least in part on at least some of the received associated card information.

2. A device as in claim 1 wherein the image and associated card information are in v-card format.

3. A device as in claim 1 wherein the image of the business card includes a representation of a name and wherein the associated card information includes the name, and wherein the storing mechanism stores the card based on the name.

4. A device as in claim 1 wherein the image of the business card includes a representation of a telephone number and wherein the associated information includes the telephone number, and wherein the storing mechanism stores the card based on the telephone number.

5. A device as in claim 1 further comprising:
a tracking mechanism constructed and adapted to track other devices to which this device sends an electronic business card.

6. A device as in claim 5 further comprising:
a mechanism constructed and adapted to automatically update cards sent to other devices when a previously sent card is changed.

7. A device as in claim 1 wherein the sending mechanism uses at least one of: wireless transmission, and physical transmission.

8. A device as in claim 1 wherein the receiving mechanism uses at least one of: wireless transmission, and physical transmission.

9. A device as in claim 1 wherein the memory is removable from the device.

10. A device as in claim 1 further comprising:
a controller adapted and constructed to control the sending and receiving of electronic business cards via the sending mechanism and the receiving mechanism respectively.

11. In a system using electronic business card devices, a method comprising, by a first electronic business card device:
storing an electronic business card consisting of at least an image of a business card along with associated card information derivable from and associated with the business card;
communicating with a second electronic business card device to determine whether a current version of the stored electronic business card has been sent to the second electronic business card device; and, based on said determining,
sending at least the image of the stored business card and the associated card information derivable from and associated with the business card to the second electronic business card device when the current version of the stored electronic business card has not been sent to the second electronic business card device.

12. A method as in claim 11 further comprising:
tracking other electronic business card devices to which a stored electronic business card has been sent.

13. A method as in claim 11 wherein the image and associated card information are in v-card format.

14. A program product for causing a first electronic device to perform a method of:
storing a first electronic business card consisting of at least an image of a first business card along with associated card information derivable from and associated with the first business card;
sending at least the image of the first business card and the associated card information derivable from and associated with the first business card to a second electronic device;
receiving a second electronic business card consisting of at least an image of a second business card along with associated card information derivable from and associated with the second business card; and
storing the received second electronic business card,
wherein stored electronic business cards are indexed by the associated card information derivable from and associated therewith.

15. A program product as in claim 14
wherein the second electronic business card is received from the second electronic device, and
wherein the sending and the receiving are performed during an exchange of electronic business cards between the first electronic device and the second electronic device.

16. A program product as in claim 14 further comprising:
downloading the first electronic business card from a server.

17. A program product as in claim 14 wherein associated card information comprises at least one of a name a phone number, and an email address.

18. A program product as in claim 17 wherein stored electronic business cards are indexed by more than one of the name, the phone number and the email address of each stored electronic business card.

19. A program product as in claim 14 further comprising:
communicating with the second electronic device to determine whether a current version of the first electronic business card has been sent to the second electronic device,
wherein the sending step is only performed if the current version of the first electronic business card has not been sent to the second electronic device.

20. A program product as in claim 14 further comprising:
communicating with the second electronic device to determine whether a current version of the second electronic business card has been received from the second electronic device,
wherein the receiving step is only performed if the current version of the second electronic business card has not been received from the second electronic device.
